(19) United States
(12) Patent Application Publication
(10) Pub. No.: US 2004/0143541 A1
(43) Pub. Date: Jul. 22, 2004

(54) Limit move insurance

(76) Inventor: Mark O. Fleischer, Los Angeles, CA (US)

Correspondence Address: HOGAN & HARTSON L.L.P., 500 S. GRAND AVENUE, SUITE 1900, LOS ANGELES, CA, 90071-2611, US

(21) Appl. No.: 10/746,735

(22) Filed: Dec. 23, 2003

Related U.S. Application Data
(60) Provisional application No. 60/440,140, filed on Jan. 15, 2003.

(51) Int. Cl. G06F 17/60

(52) U.S. Cl. 705/37

(57) ABSTRACT

The present invention discloses a method for insuring against limit moves and also discloses limit move insurance. The present invention comprises insuring against the loss created when limit trading prices are exceeded by commodity market pricing swings.

### CROSS-REFERENCE TO RELATED APPLICATIONS

This application claims priority under 35 U. S. C. § 119(e) of U.S. Provisional Patent Application No. 60/440,140, filed Jan. 15, 2003, entitled “LIMIT MOVE INSURANCE,” by Mark O. Fleischer, which application is incorporated by reference herein.

### BACKGROUND OF THE INVENTION

1. Field of the Invention

The present invention relates in general to commodity futures, and in particular to insurance against losses due to the movement of prices beyond predefined limits, also referred to as limit move insurance.

2. Description of the Related Art

The trader in the commodity futures markets is potentially subject to losses beyond the trader's control. One circumstance where such a loss can occur is when the price of a commodity moves (in a losing direction for the trader) past the limit set by the exchange, and trading past that limit is suspended before the broker can execute the trader's standing order to liquidate the trader's position at a preset amount of loss. Because the price for the commodity is now in a loss position greater than that at which the trader wished to liquidate, the trader suffers an uncontrolled loss equal to the difference in price between the actual liquidation price and the liquidation price set by the limit price.

During the period 1990 to 1999, over 3.3 billion commodities futures contracts were entered into relating to commodities which were subject to daily price limits. As each contract requires a buyer and a seller, over 6.6 billion such transactions occurred—each potentially insurable.

It can be seen, then, that there is a need for the ability to protect against losses that are created by the rapid movement of prices in the market. It can also be seen that there is a need in the art for an insurance product that can protect against such losses.

### SUMMARY OF THE INVENTION

To minimize the limitations in the prior art described above, and to minimize other limitations that will become apparent upon reading and understanding the present invention, the present invention discloses a method for insuring against limit moves and also discloses limit move insurance. The present invention comprises insuring against the loss created when limited trading prices are exceeded by commodity market pricing swings.

An object of the present invention is to provide the ability to protect against losses that are created by the rapid and other movement of prices in the market. Another object of the present invention is to provide an insurance product that can protect against such losses.

### BRIEF DESCRIPTION OF THE DRAWINGS

Referring now to the drawings in which like reference numbers represent corresponding parts throughout:

FIG. 1 illustrates an example of the loss in a descending market when a stop loss order cannot be executed;

FIG. 2 illustrates an example of the loss in a ascending market when a stop loss order cannot be executed; and

FIG. 3 illustrates an example of the loss in a descending market when a stop loss order is placed and cannot be executed.

### DETAILED DESCRIPTION OF THE PREFERRED EMBODIMENTS

In the following description of the preferred embodiments, examples and illustrations are shown of specific embodiments in which the invention may be practiced. It is to be understood that other embodiments may be utilized and organizational changes may be made to the examples and illustrations disclosed herein without departing from the scope of the present invention.

Overview

The purpose of the present invention is to provide coverage of a portion of a commodity futures trader's losses caused by a specific unusual and carefully defined event, under a mass-market product priced so as to be attractive to the trader and highly profitable for the insurer.

The trader in the commodity futures markets is potentially subject to losses beyond the trader's control. One circumstance where such a loss can occur is when the price of a commodity moves (in a losing direction for the trader) past the limit set by the exchange, and trading past that limit is suspended before the broker can execute the trader's standing order to liquidate the trader's position at a preset amount of loss or gain. The proposed invention comprises an insurance product, which will insure a trader under the foregoing circumstances against a loss measured by the difference between the price of where the broker had a standing order to liquidate the trader's position and the price where the broker is next able to liquidate the trader's position after normal trading is resumed. Further, if a limit is passed without trading ceasing, and the price continues to fall, a related embodiment of the present invention allows for recovery of losses in such situations.

During the period 1990 to 1999, over 3.3 billion commodities futures contracts were entered into relating to commodities, which were subject to daily price limits. As each contract requires a buyer and a seller, over 6.6 billion such transactions occurred—each potentially insurable by the present invention.

The historical outside risk to the insurer has been reviewed, and a premium/deductible pricing structure has been determined that would cover the risk and deliver to the insurer a substantial profit, and be price-effective and marketable to the insured.

Based on the frequency and dollar magnitude of all the limit moves during the entire 1990-1999 study period, it has been determined that, if all subject transactions were insured, and a deductible were applied to each claim equal to one-half of a reasonable initial margin requirement relating to the commodity being insured, only $2.77 of each premium would be needed to cover the aggregate claims. Therefore, if a premium of, for example, $8.77 were charged, the available after-claim profit pool to the insurers and brokers would be $6.00 per insured transaction. In 1999, there were approximately 320,000,000 transactions in commodities subject to limit moves. If only 1% of these transactions were insured, the after-claim profit pool would have been almost $20,000,000.

Usually, a new product of this nature is faced with an almost insurmountable challenge: distribution. In this case, the solution to that problem is built-in: no trader can trade without a broker. Every time a trader calls a broker to enter a trade, the broker is in a position to ask the trader if he or she wishes to purchase Limit Move Insurance for $8.77 per commodities contract being purchased by the trader. If the trader agrees, the premium is simply deducted from the trader's account with the broker or charged as an item on the trader's bill. The broker would be entitled to a percentage of the premium to motivate the broker to sell the insurance. Further, the broker is in an excellent position to promote the insurance product at minimal cost in its newsletters and other communications to its clients. This product is also particularly adaptable to the fast growing area of electronic trading: before a trade is entered into, the computer screen can easily ask:

“Do you want Limit Move Insurance at $______ per contract? Yes/No.”

This insurance product provides the trader, at an attractive price, peace of mind against the possibility of being trapped in a devastating limit move. And if 5% of the yearly transactions were insured, based on 1999 figures the insurer/brokers would collectively receive an after-claim gross profit of approximately $100,000,000 annually.

Stock Market Versus Commodities Market Comparisons

In the stock market, the trader usually makes an out of pocket investment by purchasing a particular stock and that investment appreciates or depreciates with the rise and fall of the price of the stock. The trader's maximum risk is that the price will fall to zero and the stock will become worthless. The trader's risk, therefore, is limited to the trader's investment in the stock, plus any brokers' commissions that are due.

In the commodities market, however, the situation is reversed. The trader makes no investment in the commodity, other than paying in and maintaining a “margin” requirement in the trader's account with the broker. The margin is a sum of money, depending on the particular commodity involved, essentially used by the broker as collateral to secure the broker against the trader's losses. The trader then gains or loses, dollar for dollar without upside or downside limit, each time the price of the commodity moves away from the price at which the trader entered the market. For example, if the trader enters the Soybean market in a long position (expecting the price to rise) and three days later the price of Soybeans goes up $500, then the broker actually deposits $500 into the trader's account and the trader is free to liquidate the Soybean position at any time and walk away with the $500, less any commissions due. If the price goes down $500, the broker withdraws $500 from the trader's account, and keeps withdrawing money from the trader's account if the price continues to fall until the price stops falling or the trader liquidates the Soybean position.

If there is insufficient money in the trader's account to cover the trader's losses plus a cushion (or reserve against future losses) for any particular commodity in which the trader is holding positions, the broker can require the trader to deposit more money in the account (known as a “margin call”). If the trader is unable to meet the margin call, the broker can liquidate any or all of the trader's positions in other markets handled by the broker to cover the losses. If the funds in the account are still insufficient, the broker can foreclose on the other personal assets of the trader (property, vehicles, etc.) to cover the losses.

Risk Management

Trading in the commodities futures markets is, therefore, largely a matter of managing risk. The trader can control where the trader enters the market and (under most circumstances) where the trader exits the market. Very often a trader, at the time he or she enters a market, will set a limit on the amount of loss the trader is willing to sustain. By far the most common technique for accomplishing this is the placement of a stop loss order with the broker at the time the trader enters the market.

For example, on Oct. 30, 2000, a trader thinks that May 2001 Soybean Oil may have bottomed out at 15.63. Seeing the price rise to 16.35 on December 22 and then fall off, the trader believes that if the price goes back up and breaks through that 16.35 resistance point the downtrend of the Soybean Oil market will be reversed. Accordingly, the trader places an order with his or her broker to go long (or buy) one contract of May 2001 Soybean Oil if the price goes back up to 16.35.

The trader also believes that if the price goes up to that level but then falls back down to or below the 15.63 mark (where the trader thought Soybean Oil had bottomed out), then the downward trend had not really been reversed and that the trader had better exit this market at that point to prevent further losses. Accordingly, the trader places a stop loss order with the broker providing that if the order to buy the Soybean Oil contract at 16.35 is filled, than a simultaneous order is given to the broker to liquidate (or sell) that contract of Soybean Oil at 15.63 should the price fall that low.

This way, the trader is managing his or her risk from the beginning. The trader is controlling where he or she enters the market, exits the market, and how much money he or she is prepared to lose if he or she guessed wrong and the market goes in the wrong direction. If the order is filled and the price subsequently drops to the stop loss order, the broker will take the trader out with a 72 point loss. For Soybean Oil, each point is worth $6.00 (every commodity has a “point value” which is used to convert contract unit prices into dollars and cents), so the loss would be $432.00. If the trader were firmly convinced that Soybean Oil was going to go up but did not want to risk that much, the trader could simply have placed the stop loss order higher (for example at 16.00, which would have limited the trader's loss to 35 points, or $210.00).

The same technique is used when the trader believes that a market will go down. If the trader enters the market in a short position, the trader will simultaneously place a stop loss order above the entry point. Should the market subsequently rise to that stop loss order point, the broker will liquidate that contract. Stop loss orders can be raised or lowered at any time, and, once a trade is in profits, can be used to protect those profits.

While the stop loss order is usually an effective means of controlling loss, occasionally a market moves so quickly or otherwise that the broker is physically unable to fill the stop loss order before the market has moved beyond that stop loss point. The point at which the broker will first be able to fill the stop loss order is determined by market conditions only and is completely beyond the control of the broker. While that point is often only slightly past the stop loss order, sometimes it is significantly past the stop loss order. Thus, the point spread between where the trader chooses to exit the market by placing a stop loss order and where the broker is actually able to fill that order in a swiftly moving or volatile market represents a corridor of risk that cannot be managed or controlled. It is referred to in this discussion as the “Uncontrolled Loss.”

Daily Price Limit Moves

To prevent markets from accelerating too swiftly, some Commodities Exchanges have imposed rules over certain (but not all) commodities that place limits on the amount the price of a particular commodity may move (up or down) in a trading session. The particular number of points the price can move is known as the □ daily price limit,“ and if the price of a commodity moves its daily price limit, that commodity has experienced what is referred to as a □ limit move.” When the daily price limit is reached, no trading is permitted at a price beyond that limit for a particular period of time (usually 24 hours or the opening of the next trading session), although trades are still permitted within the price limit. Price moves are measured from where the price closed (or more accurately, settled) the night before.

At what price trading will resume for that commodity is governed entirely by market conditions. The price for the relevant commodity may reopen above or below where it was suspended (regardless of whether the limit move was up or down), and may reopen very near where it was suspended or very far away.

Of particular concern to traders is the possibility of being in a market which moves against them so swiftly that their stop loss order can not be filled before trading in the losing direction is suspended due to the daily price limit being reached; the price of the commodity may then reopen so far from the price of the stop loss order that a significant Uncontrolled Loss might occur.

On example is the Soybean Oil limit move that occurred on Jul. 5, 1994. Soybean Oil closed on July 1 (the previous trading session) at 25.67, opened on July 5, moved its daily price limit of 1.00 to 24.67. For the rest of the trading session no further trades in Soybean Oil are permitted at a price lower than 24.67 (although trades at prices of 24.67 or above are still permitted). Trading reopened the next day at 24.75. If a trader with a long position had a stop loss order of 25.67, and that order could not be filled before downward trading was suspended because the market moved too swiftly, the stop loss order would not have been able to be filled until the market reopened the next day at 24.75. This would have resulted in an Uncontrolled Loss of 92 points or $552. If the stop loss order had been at 25.57, the Uncontrolled Loss would have been 42 points, or $252. If the stop loss order had been at 24.70, there would have been no Uncontrolled Loss—the market opened the next day higher than the stop loss order, so the trader's loss was less than that which the trader was prepared to incur when her or she entered the market and placed the stop loss order.

The Present Invention

The present invention is intended to cover a trader's Uncontrolled Loss resulting from a daily price limit move. Two conditions must exist for the loss to be covered:

1. The trader must have a stop loss order placed with the broker at the time of a limit move; and

2. The market moved too swiftly to allow the stop loss order to be filled before trading in the losing direction was suspended due to the daily price limit being reached.

The Uncontrolled Loss would equal the price spread between the price of the trader's stop loss order and the price where the stop loss order could first be filled after trading is resumed. While no policy limits are recommended, a premium/deductible structure can be developed to make this a profitable product for the insurer and an attractive product for the insured.

As the example described below indicates, the economics are such that the premium and deductible can be low enough to be marketable to the trader, yet high enough, when aggregated with all of the other premiums, to cover the aggregate losses under all policies and still deliver a very attractive profit/return on investment to the insurer. The deductible should be measured as a percentage of the margin requirement for the relevant commodity being insured (as margins requirements are set at a level sufficiently low to be acceptable to the traders yet sufficiently high to protect the brokers from the foreseeable losses incurred by the traders).

In fact, based on the actuarial findings of the 10 year study below, the appropriate premium/deductible structure will result in the reasonably foreseeable risk to the insurer being measured only in terms of greater or lesser profit, not in out of pocket loss.

Data Reviewed to Determine Viability of the Present Invention

A preliminary research study (The Study) was performed to determine the viability of the present invention in today's marketplace. While there are over 56 heavily traded commodities traded over the U.S. Commodities exchanges, only 25 or so of those commodities (the “Subject Markets”) are subject to daily price limits. The Study was limited to the United States commodities exchanges and covered the years 1990 through 1999 (the “Study Period”). The Study also examined only the front month of each Subject Market and assumed that, if a limit move occurred in the front month of a Subject Market, a limit move also occurred in all of the other trading months of that Subject Market. The Study determined the following facts:

A. Which Subject Markets experienced limit moves during the Study Period, and how many limit moves were experienced. The Study examined the following Subject Markets and found as follows:

Lumber (Random)—339 limit moves;

Frozen Pork Bellies—308 limit moves;

Live (and Lean) Hogs—82 limit moves;

Rice—49 limit moves;

Feeder Cattle—45 limit moves;

Corn (CBOT only)—39 limit moves;

Live Cattle—37 limit moves;

Cotton—21 limit moves;

Orange Juice—21 limit moves;

Oats—20 limit moves;

Soybean Meal—16 limit moves;

Soybeans (CBOT only)—15 limit moves;

Soybean Oil—15 limit moves;

Wheat (CBOT only)—15 limit moves;

Platinum—3 limit moves;

Cocoa (CSCE only)—0 limit moves;

Coffee (CSCE only)—0 limit moves;

Crude Oil (but not Brent Oil)—0 limit moves;

Gold—0 limit moves;

Heating Oil—0 limit moves;

High Grade Copper—0 limit moves;

Natural Gas—0 limit moves;

Silver (5000 oz. COMEX only)—0 limit moves;

Sugar # 11 CSCE only)—0 limit moves;

Unleaded Gas—0 limit moves.

B. The dates on which every Subject Market experienced a limit move during the Study Period (although the Study did not examine consecutive limit days).

C. The price of the relevant Subject Market (1) on close of the day before the limit move, (2) on open of the day of the limit move, (3) on close of the day of the limit move, and (4) on open of the day after the limit move.

D. The Open Interest (i.e., the number of futures contracts in existence) of the relevant Subject Market on each day it experienced a limit move.

E. The annual Volume of futures trading (i.e., the number of futures contracts entered into) during the Study Period.

2. The proposed insurance product is intended to cover the trader's “Uncontrolled Loss,” as described above. To determine the Uncontrolled Loss, it would have been necessary to determine what every trader's stop loss order actually was for every limit move during the Study Period. As this was impossible to do, a model was developed which calculated the Uncontrolled Loss of every trade utilizing three hypothetical stop loss order placements. Theses placements were expressed in terms of possible point spread as follows: a maximum (“high”), minimum (“low”), and middle (“probable” or “prob”). Using these hypothetical stop loss orders, the applicable price spreads were calculated.

A. The maximum spread possible would be to assume that every trader placed a stop loss order where the market closed on the day before the limit move and that the market moved so quickly on opening the next day (the day of the limit move) and was thereafter suspended in the direction of the move that the stop loss order could only be filled when trading opened the day after the limit move.

Examples of Limit Moves in Various Markets

(1). Example in a Descending Market

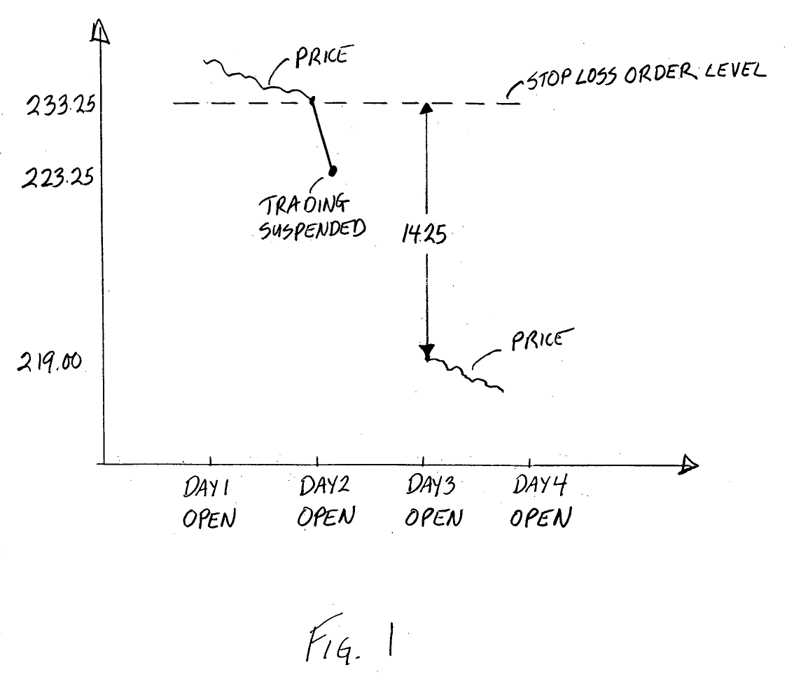

FIG. 1 illustrates an example of the loss in a descending market when a stop loss order cannot be executed. The daily price limit move for Oats is 10 cents. On day 1, Oats closed at 233.25. On day 2, Oats opened and moved downward 10 cents (its daily price limit) to 223.25, and downward trading past 223.25 was suspended. On day 3, Oats opened at 219.00. Assume that the trader with a long position in Oats had a stop loss order at 233.25 (where Oats closed on day 1) which was not filled at the end of day 1 and that once the market opened on day 2 it moved downward so quickly that the stop loss order could not be filled before downward trading was suspended at 223.25.

The first time the trader could have exited the market was when trading opened on day 3 at 219.00. The price spread between the stop loss order at 233.25 which could not be filled on day or day 2 and where the order could first be filled when trading resumed at opening on day 3 at 219.00 is 14.25. Therefore, the “high” exposure to the trader with a long position for this particular limit move was 14.25, or measured in actual dollar loss, $712.50 (the point value for Oats being 1 cent=$50). See FIG. 1.

(2). Example in an Ascending Market

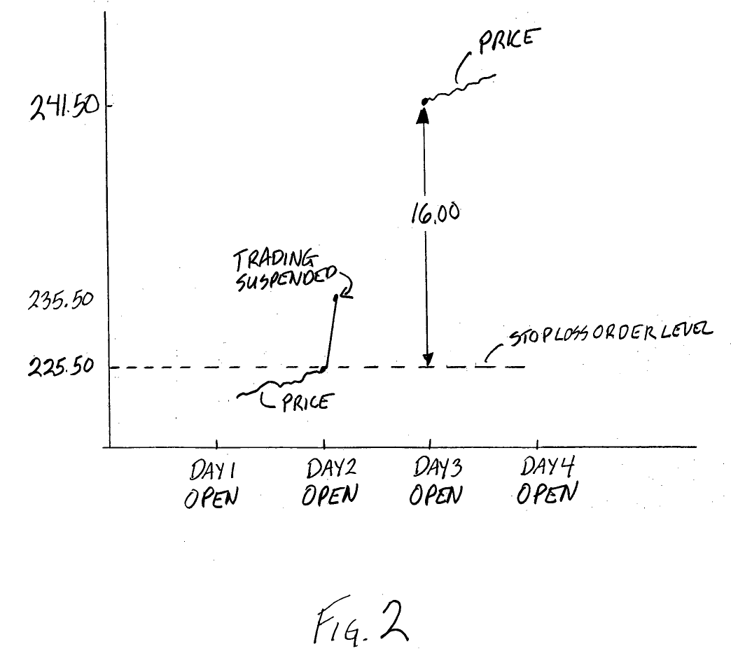

FIG. 2 illustrates an example of the loss in a ascending market when a stop loss order cannot be executed. On day 1, Oats closed at 225.50. On day 2, Oats opened and moved upward 10 cents (its daily price limit) to 235.50 and upward trading was suspended at 235.50. On day 3, Oats opened at 241.50. Assume that the trader with a short position in Oats had a stop loss order at 225.50 (where Oats closed on day 1) which was not filled at the end of day 1 and that once the market opened on day 2 it moved upward so quickly that the stop loss order could not be filled before downward trading was suspended at 235.50.

The first time the trader could have exited the market was when trading opened on day 3 at 241.50. The price spread between the stop loss order at 225.50 which could not be filled on day 1 or 2 and where the order could first be filled when trading resumed at opening on day 3 at 241.50 is 16. Therefore, the “high” exposure to the trader with a short position for this particular limit move was 16, or measured in actual dollar loss, $800.00. See FIG. 2.

B. The minimum spread possible would be to assume that every trader placed a stop loss order where the market closed on the day of the limit move and that the stop loss order was filled when trading opened the next day.

The present invention can also have a component of a moving stop loss order price. For example, if the market moves upwards a certain amount, a stop loss order price can be programmed to follow the market price by a given amount, a percentage, or can also be programmed to close out an account when the market move goes up to a specific dollar amount or a specific percentage over the opening or closing price. For example, in an ascending market when a trader is in a long position, and Oats closes at 225.50 on day 1. The trader places a programmed stop loss order at 225.50, with orders to reprogram the stop loss when the price moves 5 cents upward. On day 2, Oats opened and moved upward 10 cents (its daily price limit) to 235.50 and trading was suspended. The trader would then have a stop loss order at 235.50. On day 3, Oats opened at 241.50. The trader's new stop loss order would be at 241.50. When Oats finally drops below 241.50, the trader that had purchased the insurance of the present invention would receive proceeds of sale at the price of 241.50, regardless of the actual sale price, whereas if Oats were to drop further, traders without insurance would receive their actual proceeds of sale.

Such insurance would likely cost more than other insurance listed herein, but could be a safety net for some traders that are looking to minimize losses and retain as much investment as possible. Of course, such a stop loss order would be immediately encroached when the market is in a descending direction.

(1). Example in a Descending Market

On day 1, Oats closed at 233.25. On day 2, Oats opened and downward 10 cents (its daily price limit) to 223.25, and downward trading was suspended past 223.25. On day 3, Oats opened at 219.00. Assume that the trader with a long position in Oats had a stop loss order at 223.25 (where trading in Oats was suspended on day 2) which was not filled at that time because the market moved to it so quickly that it could not be filled before downward trading was suspended.

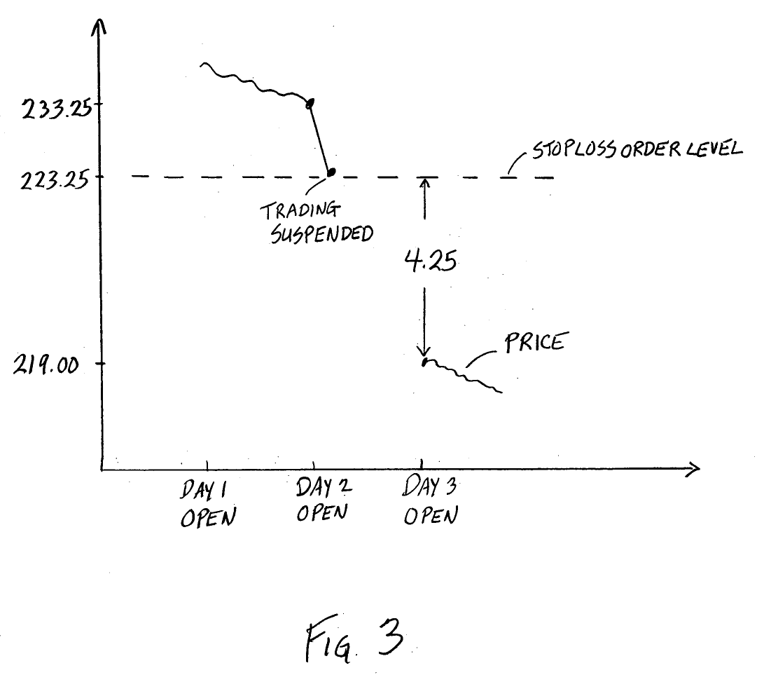

The first time the trader could have exited the market was when trading opened on day 3 at 219.00. The price spread between the stop loss order at 223.25 which could not be filled on day 2 and where the order could first be filled when trading resumed at opening on day 3 at 219.00 is 4.25. Therefore, the “low” exposure to the trader with a long position for this particular limit move was 4.25, or measured in actual dollar loss, $212.50. Note that often a market will open on day 3 higher than where downward trading was suspended on day 2, the point in this scenario where the trader placed the stop loss order. In that case, the Uncontrolled Loss is zero, as the stop loss order will be executed when the market reopens at or above the price where the stop loss order was set; thus, even though there was a limit move, there would be no claim under the insurance policy. See FIG. 3.

(2). Example in an Ascending Market

On day 1, Oats closed at 225.50. On day 2, Oats opened and moved upward 10 cents (its daily price limit) to 235.50, and upward trading was suspended past 235.50. On day 3, Oats opened at 241.50. Assume that the trader with a short position in Oats had a stop loss order at 235.50 (where upward trading in Oats was suspended on day 2) which was not filled at that time because the market moved to it so quickly that it could not be filled before upward trading was suspended.

The first time the trader could have exited the market was when trading opened on day 3 at 241.50. The price spread between the stop loss order at 235.50 which could not be filled on day 2 and where the order could first be filled when trading resumed at opening on day 3 at 241.50 is 6.00. Therefore, the “low” exposure to the trader with short position for this particular limit move was 6.00, or measured in actual dollar loss, $300.00. Note that often a market will open on day 3 lower than where upward trading was suspended on day 2, the point in this scenario where the trader placed the stop loss order. In that case, the Uncontrolled Loss is zero, as the stop loss order will be executed when the market reopens at or below the price where the stop loss order was set; thus, even though there was a limit move, there would be no claim under the insurance policy.

C. A middle (or probable) spread would be to assume that every trader placed a stop loss order at a distance from where the market closed on the day of the limit move equal to one-half of the daily price limit, and that the market moved so quickly after reaching that point and was thereafter suspended in the direction of the move that the stop loss order could only be filled when trading opened the next day.

(1). Example in a Descending Market

On day 1, Oats closed at 233.25. On day 2, Oats opened and moved downward 10 cents (its daily price limit) to 223.25, and downward trading was suspended past 223.25. On day 3, Oats opened at 219.00. Assume that the trader with a long position in Oats had a stop loss order at 228.25 (5 cents, or one-half the daily price limit, above the point where downward trading would have to be, and was, suspended at 223.25 on day 2) which was not filled at that time because the market moved passed it so quickly that it could not be filled before downward trading was suspended.

The first time the trader could have exited the market was when trading opened on day 3 at 219.00. The price spread between the stop loss order at 228.25 which could not be filled on day 2 and where the order could first be filled when normal trading resumed at opening on day 3 at 219.00 is 9.25. Therefore, the “probable” exposure to the trader with a long position for this particular limit move was 9.25, or measured in actual dollar loss, $462.50.

(2). Example in an Ascending Market

On day 1, Oats closed at 225.50. On day 2, Oats opened and moved upward 10 cents (its daily price limit) to 235.50, and upward trading was suspended past 235.50. On day 3, Oats opened at 241.50. Assume that the trader with a short position in Oats had a stop loss order at 230.50 (5 cents, or one-half the daily price limit, below the point where upward trading would have to be, and was, suspended at 235.50 on day 2) which was not filled at that time because the market moved passed it so quickly that it could not be filled before upward trading was suspended.

The first time the trader could have exited the market was when trading opened on day 3 at 241.50. The price spread between the stop loss order at 230.50 which could not be filled on day 2 and where the order could first be filled when trading resumed at opening on day 3 at 241.50 is 11. Therefore, the “probable” exposure to the trader with a short position for this particular limit move was 11, or measured in actual dollar loss, $550.00.

3. The dollar amount (on a per contract basis) of the Uncontrolled Loss for every limit move experienced by every Subject Market during the Study Period was then calculated, using all three hypothetical stop loss order placements. This calculation is identified in the Work Spreadsheets as “Per High,” “Per Low,” and “Per Prob.”

4. A calculation was then performed to determine, for each limit move in every Subject Market over the Study Period, what the total Uncontrolled Loss would have been for the aggregate contracts existing in the Subject Market on the day of such limit move, using all three hypothetical stop loss order placements (i.e., If Corn experienced a limit move down on a particular, the aggregate Uncontrolled Loss of all long positions in Corn caused by that limit move). This calculation was performed by multiplying each Per High, Per Low, and Per Prob by the Open Interest (“O/I”) existing on the day of the limit move. The results of this calculation were entered in the Work Spreadsheets as “Tot High,” “Tot Low,” and “Tot Prob,” respectively.

5. The next step was to determine the aggregate Uncontrolled Loss for the aggregate limit moves in each Subject Commodity over the Study Period, using all three hypothetical stop loss order placements. This was done by adding all of the Tot Highs, Tot Lows, and Tot Probs on a Subject Market by Subject Market basis. The results were entered in the Summary Spreadsheet as “Sum of Tot High, “Sum of Tot Low,” and “Sum of Tot Prob,” respectively.

6. It was next determined what the insurers' total possible exposure would have been if every contract in each Subject Market for the entire Study Period had been insured against Uncontrolled Loss. To determine this, the margin requirement for each Subject Market was entered on the Summary Spreadsheet next to the name of the commodity as “M=$______”. While minimum margin requirements are set by the exchanges, the actual margin amounts required by brokers vary among clearing houses. Accordingly, a reasonable margin amount was selected based on then-prevailing market conditions. Additionally, for each Subject Market the sum of all Open Interests existing on all the days a limit move was experienced by the applicable Subject Market during the Study Period was entered on the Summary Spreadsheet as “Sum of OI” The possible Uncontrolled Loss had to be determined using all three hypothetical stop loss positions and using three levels of deductible. The levels of deductible used were: (1) No deductible: (2) A deductible equal to one-half the initial margin requirement of the relevant Subject Market; and (3) A deductible equal to the full initial margin requirement of the relevant Subject Market. The calculation was performed on a Subject Market by Subject Market basis by (A) subtracting from the Sum of Tot High, Sum of Tot Low, and Sum of Tot Prob of each Subject Market, respectively, (B) the result of multiplying (x) the dollar amount of the applicable deductible by (y) the Sum of OI for the applicable Subject Market. The results were entered on the Summary Spreadsheet as follows:

A. Where no deductible was applied, the results were the existing entries of Sum of Tot High, Sum of Tot Low, and Sum of Tot Prob.

B. Where a deductible equal to one-half the initial margin requirement of the relevant Subject Market was applied, the results were entered under “Tot High Less ½ Margin,” “Tot Low Less ½ Margin,” and “Tot Prob Less ½ Margin.”

C. Where a deductible equal to the full initial margin requirement of the relevant Subject Market was applied, the results were entered under “Tot High Less Full Margin,” “Tot Low Less Full Margin,” and “Tot Prob Less Full Margin.”

7. Finally, it was determined what premium the insurer would have had to have charged on each transaction just to cover the aggregate claims over the Study Period for all three hypothetical limit order positions and all three levels of deductible. Each commodities contract (or trade) involves two transactions: one by the buyer and the other by the seller, each separately commissionable and each separately insurable. Thus the annual volume of trades for each Subject Market over the Study Period were added together and multiplied by 2. The result was entered on the Summary Spreadsheet under “Sum of Volume 1990-99×2.” The following calculations were then performed:

A. Where no deductible was applied and the High hypothetical stop loss position was utilized, the “Sum of Tot Highs” for all of the Subject Markets were added together and divided by the sum of all of the “Sum of Volume 1990-99×2” for all of the Subject Markets. The results were entered on the Summary Spreadsheet under “High Per TA Cost Less No Margin.”

B. Where no deductible was applied and the Low hypothetical stop loss position was utilized, the Sum of Tot Lows” for all of the Subject Markets were added together and divided by the sum of all of the “Sum of Volume 1990-99×2” for all of the Subject Markets. The results were entered on the Summary Spreadsheet under “Low Per TA Cost Less No Margin.”

C. Where no deductible was applied and the Prob hypothetical stop loss position was utilized, the “Sum of Tot Probs” for all of the Subject Markets were added together and divided by the sum of all of the “Sum of Volume 1990-99×2” for all of the Subject Markets. The results were entered on the Summary Spreadsheet under “Prob Per TA Cost Less No Margin.”

D. Where the deductible was equal to one-half the initial margin requirement and the High hypothetical stop loss position was utilized, the “Sum of Tot Highs” for all of the Subject Markets were added together and divided by the sum of all of the “Sum of Volume 1990-99×2” for all of the Subject Markets. The results were entered on the Summary Spreadsheet under “High Per TA Cost Less ½ Margin.”

E. Where the deductible was equal to one-half the initial margin requirement and the Low hypothetical stop loss position was utilized, the “Sum of Tot Lows” for all of the Subject Markets were added together and divided by the sum of all of the “Sum of Volume 1990-99×2” for all of the Subject Markets. The results were entered on the Summary Spreadsheet under “Low Per TA Cost Less ½ Margin.”

F. Where the deductible was equal to one-half the initial margin requirement and the Prob hypothetical stop loss position was utilized, the “Sum of Tot Probs” for all of the Subject Markets were added together and divided by the sum of all of the “Sum of Volume 1990-99×2” for all of the Subject Markets. The results were entered on the Summary Spreadsheet under “Prob Per TA Cost Less ½ Margin.”

G. Where the deductible was equal to the full initial margin requirement and the High hypothetical stop loss position was utilized, the “Sum of Tot Highs” for all of the Subject Markets were added together and divided by the sum of all of the “Sum of Volume 1990-99×2” for all of the Subject Markets. The results were entered on the Summary Spreadsheet under “High Per TA Cost Less Full Margin.”

H. Where the deductible was equal to the full initial margin requirement and the Low hypothetical stop loss position was utilized, the “Sum of Tot Lows” for all of the Subject Markets were added together and divided by the sum of all of the “Sum of Volume 1990-99×2” for all of the Subject Markets. The results were entered on the Summary Spreadsheet under “Low Per TA Cost Less Full Margin.”

I. Where the deductible was equal to the full initial margin requirement and the Prob hypothetical stop loss position was utilized, the “Sum of Tot Probs” for all of the Subject Markets were added together and divided by the sum of all of the “Sum of Volume 1990-99×2” for all of the Subject Markets. The results were entered on the Summary Spreadsheet under “Prob Per TA Cost Less Full Margin.”

Possible Pricing Structures for the Present Invention

The pricing structures listed herein are for a generic limit move insurance product. However, other pricing structures are envisioned within the scope of the present invention, such as pricing the limit move insurance by commodity, where more volatile commodities may demand higher premium prices. Further, pricing may be based on whether the trader has used a moving stop price, and whether that moving stop price is moved daily, weekly, by percentage, or by opening or closing prices. The price can also be based on a deductible, and the deductible can be based on the underlying commodity if desired.

Before a deductible and premium could be evaluated and determined, a decision was made as to which hypothetical stop loss position was most appropriate to select as an underlying assumption. The Prob hypothetical stop loss position was selected for three reasons: (1) it was at neither extreme; (2) in many insured transactions the stop loss order will have been placed outside the range of the limit move entirely, and (3) in many insured transactions, on the day of a limit move the market will move slowly enough for the stop loss order to be filled before trading is suspended.

Based on the foregoing, the present invention could be priced as follows. The pricing structures are presented for purposes of illustration and are not intended to limit the scope of the present invention:

A. A deductible equal to ½ the initial margin requirement of the applicable commodity; and

B. A premium of $8.77. The term of the policy would be the life of the futures commodity contract insured (although additional study should be performed to determine if a somewhat higher premium should be charged on further out trading months, as they have a longer time in which to experience a limit move).

The Prob Per TA Cost Less ½ Margin was $1.77. Therefore, under this structure, $1.77 of each premium would be used to pay the aggregate Uncontrolled Losses, and the remaining $6.00 would be the gross profit pool to be shared on some basis among the insurer and the brokers. In 1999, the aggregate number of transactions for all of the Subject Markets equaled approximately 320,000,000. If 1% of the transactions had been insured, the available profit pool for the insurer and brokers would equal almost $20,000,000 for that year alone. If 5% of the transactions had been insured, the profit pool for that year would have been almost $100,000,000.

Summary

In summary, the present invention discloses a method for insuring against limit moves and also discloses limit move insurance. The present invention comprises insuring against the loss created when limit trading prices are exceeded by rapidly moving commodity market pricing swings.

Although described herein with respect to limit moves in the commodities markets, the present invention can be utilized with respect to options trading or margin account trading on the stock exchanges, such as the NYSE, NASDAQ, and AMEX. It is envisioned that the scope of the present invention encompasses such trading structures.

The foregoing description of the preferred embodiments of the present invention have been presented for the purposes of illustration and description. It is not intended to be exhaustive or to limit the invention to the precise form disclosed. Many modifications and variations are possible in light of the above teachings. It is intended that the scope of this invention not be limited by this detailed description, but by the claims and equivalents to the claims appended hereto.

What is claimed is:

1. A method of insuring against losses, comprising:
(a) placing a stop order on a commodity at a first price;
(b) having trading of the commodity in a losing direction be suspended prior to the stop order being exercised at the first price;
(c) having normal trading of the commodity resume at a second price which is different than the first price wherein the second price would trigger the stop order; and
(d) paying at least a portion of the difference between the first price and the second price to a holder of the stop order.

2. The method of claim 1, wherein the holder of the stop order pays a premium to insure the payment of the difference between the first price and the second price.

3. The method of claim 2, wherein the holder of the stop order holds a long position in the commodity.

4. The method of claim 3, wherein the commodity is a mercantile commodity.

5. The method of claim 4, wherein the mercantile commodity is selected from a group comprising lumber, frozen pork bellies, live hogs, rice, feeder cattle, corn, live cattle, cotton, orange juice, oats, soybean meal, soybeans, soybean oil, wheat, platinum, cocoa, coffee, crude oil, gold, heating oil, high grade copper, natural gas, silver, sugar, and unleaded gasoline.

6. The method of claim 3, wherein the commodity is a securities offering.

7. The method of claim 6, wherein the securities offering is offered on an exchange selected from a group comprising the New York Stock Exchange, the NASDAQ, and the American Stock Exchange.

8. The method of claim 5, wherein a price of the premium and a size of the portion of the difference is determined by a deductible paid by the holder of the stop order.

9. The method of claim 8, wherein the price of the premium is further determined by an amount of profit made on each premium.

10. The method of claim 5, wherein a price of the premium is a fixed price.

11. The method of claim 2, wherein the holder of the stop order holds a short position in the commodity.

12. The method of claim 11, wherein the commodity is a mercantile commodity.

13. The method of claim 12, wherein the mercantile commodity is selected from a group comprising lumber, frozen pork bellies, live hogs, rice, feeder cattle, corn, live cattle, cotton, orange juice, oats, soybean meal, soybeans, soybean oil, wheat, platinum, cocoa, coffee, crude oil, gold, heating oil, high grade copper, natural gas, silver, sugar, and unleaded gasoline.

14. A method for insuring against limit move losses, comprising:
(a) placing a stop order on a commodity at a first price;
(b) having trading of the commodity in a losing direction be suspended prior to the stop order being exercised at the first price;
(c) having normal trading of the commodity resume at a second price which is lower than the first price;
(d) selling the commodity at a third price, wherein the third price is lower than the first price; and
(e) paying at least a portion of the difference between the first price and the third price to a holder of the stop order.

15. The method of claim 14, wherein the third price is substantially the same as the second price.

16. The method of claim 15, wherein the holder of the stop order holds a long position in the commodity.

17. The method of claim 16, wherein the commodity is a mercantile commodity.

18. The method of claim 17, wherein the mercantile commodity is selected from a group comprising lumber, frozen pork bellies, live hogs, rice, feeder cattle, corn, live cattle, cotton, orange juice, oats, soybean meal, soybeans, soybean oil, wheat, platinum, cocoa, coffee, crude oil, gold, heating oil, high grade copper, natural gas, silver, sugar, and unleaded gasoline.

19. The method of claim 15, wherein the holder of the stop order holds a long position in the commodity.

20. The method of claim 19, wherein the commodity is a mercantile commodity.
